(19) United States
(12) Patent Application Publication
(10) Pub. No.: US 2026/0322733 A1
(43) Pub. Date: Oct. 15, 2026

(54) METHOD FOR SUBSCRIBING TO MULTICASTS IN A MESH COMMUNICATION NETWORK OF THE LOCAL NETWORK TYPE

(71) Applicant: SAGEMCOM BROADBAND SAS, Bois-Colombes (FR)

(72) Inventors: Laurent ALARCON, Bois-Colombes (FR); Sylvain LE ROUX, Bois-Colombes (FR); Antonie ROCQUELAY, Bois-Colombes (FR)

(73) Assignee: SAGEMCOM BROADBAND SAS, Bois-Colombes (FR)

(21) Appl. No.: 19/248,049

(22) Filed: Jun. 24, 2025

(30) Foreign Application Priority Data
Jun. 26, 2024 (FR) 2406878

(51) Int. Cl. H04L 45/16

(52) U.S. Cl. CPC H04L 45/16

(57) ABSTRACT

In a mesh communication network, bridge devices use in parallel: a first configuration of a first logical network, for conveying data packets in unicast mode in accordance with dynamic routing between the bridge devices; and a second configuration of a second logical network, for conveying data packets in broadcast mode, according to a spanning tree eliminating potential loops. Following a subscription request received from a station device, each bridge device is instructed to initiate a search for the source of the multicast data stream. When the multicast data stream is received via an input port of a said bridge device, said bridge device is configured to switch the multicast data stream from the input port to an output port in the direction of the station device according to the first configuration.

### TECHNICAL FIELD

The present invention relates to multicasts of data packets in a mesh communication network of the local area network (LAN) type in which bridge devices are interconnected.

### PRIOR ART

Several solutions exist for implementing a mesh communication network of the local area network type, for example to connect wireless (e.g. Wi-Fi) network extenders to a residential gateway, and in particular bridge-device technologies.

However, in the context of these solutions, a spanning tree is defined for transmissions of the broadcast type and of the multicast type so as to connect all the bridge devices while eliminating any loop in the mesh communication network. Loops in the mesh communication network then introduce redundancies that are used as a backup path if a main path of the spanning tree were to fail. The spanning tree is then redefined in order to use such backup paths rather than faulty main paths that were used previously. Nevertheless, at a given instant, only the main paths are used for all the communications in the mesh communication network, then preventing the implementation of a specific routing of the data packets. Such a topology in fact makes it possible to optimise only communications from and to the root of said spanning tree.

For transmissions of the multicast type, two modes exist:
a dense mode in which each bridge device constructs a spanning tree of which it is itself the root. It can then flood this spanning tree with a stream of multicast data and next prune the branches where there are bridge devices not concerned by the stream of multicast data in question;
a sparse mode in which a source of a stream of multicast data is registered with a central point, sometimes called a rendezvous point (or RVP), which is the root of the spanning tree and from which the multicast data stream, supplied by the source, floods the spanning tree.

The consequence of this is that, in the case of mesh communication networks, transmissions of the multicast type can be improved.

### DISCLOSURE OF THE INVENTION

It is desirable to overcome the aforementioned drawbacks of the prior art. It is in particular desirable to provide a solution that makes it possible to improve the routing of data packets in transmissions of the multicast type in such mesh communication networks, in order to better benefit from the redundancy offered by their meshing rather than relying on a spanning tree for conveying these data packets.

A method is proposed here for transmitting data packets in a mesh communication network of the local area network type that interconnects bridge devices, each bridge device using in parallel: a first configuration of a first logical network that is used for conveying data packets in unicast mode and is defined by dynamic routing between the bridge devices; and a second configuration of a second logical network that is used for conveying data packets in broadcast mode and is defined according to a spanning tree by blocking one or more ports of bridge devices to eliminate one or more loops in the mesh communication network. The method comprises: following a first subscription request received from a station device connected to the local area network, instructing each bridge device to initiate a search for the source of the multicast data stream so that each bridge device transmits, on each of its ports, a second request to subscribe to the multicast data stream and does not take account of any such second request to subscribe to the multicast data stream coming from any other said bridge device and, when the multicast data stream is received via an input port of a said bridge device, configuring said bridge device to switch the multicast data stream from the input port to an output port in the direction of the station device according to the first configuration of a first logical network.

Thus, routing data packets in transmissions of the multicast type relies on the first configuration of a first logical network rather than on the second configuration of a second logical network, which makes it possible to optimise the conveying of transmissions of the multicast type in the mesh communication network of the local area network type (lower conveying cost compared with a solution where the spanning tree used for the broadcasts is also followed for the multicasts).

In a particular embodiment, the first subscription request is received from the station device by a said bridge device that relays the first subscription request to a centralising bridge device, which then sends to each bridge device an instruction to initiate the search for the source of the multicast data stream.

In a particular embodiment, the subscription request received from the station device is received by a said bridge device, which then sends to each bridge device an instruction to initiate the search for the source of the multicast data stream.

In a particular embodiment, each second subscription request is transmitted on behalf of the bridge device in question although it is made on behalf of the station device in question.

In a particular embodiment, each bridge device implements a table of orientation of multicast data streams containing, for each multicast data stream passing through said bridge device: a layer 3 address of the OSI (“Open Systems Interconnection”) model of said multicast data stream; a layer 2 address of the OSI model of the multicast data stream that was obtained by applying a conversion rule using said layer 3 address of the OSI model of said multicast data stream; an identification of the input port of said device for said multicast data stream; and an identification of each output port of said bridge device for said multicast data stream. Furthermore, each bridge device retranscribes its table of orientation of multicast data streams into a switching table for the multicast data streams at layer 2 of the OSI model.

A computer program product is also proposed here, comprising instructions causing an implementation of the above method according to any one of the disclosed embodiments, when the instructions are executed by a processor. An information storage medium is also proposed here, comprising instructions causing an implementation of the above method according to any one of the disclosed embodiments, when the instructions are read from the information storage medium and executed by a processor.

A bridge device is also proposed, intended to be used in a mesh communication network of the local area network type, the bridge device using in parallel: a first configuration of a first logical network that is used for conveying data packets in unicast mode and is defined by dynamic routing between bridge devices in the mesh communication network; and a second configuration of a second logical network that is used for conveying data packets in broadcast mode and is defined according to a spanning tree by blocking one or more ports of the bridge devices in the mesh communication network to eliminate one or more loops. The bridge device comprises electronic circuitry configured to: following a first subscription request received from a station device connected to the local area network, instruct each bridge device in the mesh communication network to initiate a search for the source of the multicast data stream so that each bridge device in the miscommunication network transmits, on each of its ports, a second request to subscribe to the multicast data stream and does not take account of any such second request to subscribe to the multicast data stream coming from any other said bridge device of the mesh communication network; and, when the multicast data stream is received via an input port of a said bridge device, configure said bridge device to switch the multicast data stream from the input port to an output port in the direction of the station device according to the first configuration of a first logical network.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically a mesh communication network;

FIG. 2 illustrates schematically an example of a hardware arrangement adapted to implement a device in the mesh communication network;

FIG. 3 illustrates schematically a flow diagram of an algorithm for processing a request to subscribe to a multicast data stream, received from a station device by a bridge device;

FIG. 4 illustrates schematically a flow diagram of an algorithm for processing, by the centralising bridge device, a request to subscribe to a multicast data stream, relayed by a bridge device;

FIG. 5 illustrates schematically a flow diagram of an algorithm for processing, by a bridge device, an instruction to initiate a search for the source of a multicast data stream on behalf of a station device;

FIG. 6 illustrates schematically a flow diagram of an algorithm for processing, by a bridge device, a request to subscribe to a multicast data stream, received from another bridge device;

FIG. 7 illustrates schematically a flow diagram of an algorithm for reacting, by a bridge device, to a reception of a multicast data stream for which a subscription request was previously made on behalf of a station device;

FIG. 8 illustrates schematically a table of orientation of the multicast data streams;

FIG. 9A illustrates schematically a first part of an example of establishing a transmission of a multicast data stream in the mesh communication network;

FIG. 9B illustrates schematically a second part of the example of establishing a transmission of a multicast data stream in the mesh communication network;

FIG. 9C illustrates schematically a third part of the example of establishing a transmission of a multicast data stream in the mesh communication network;

FIG. 9D illustrates schematically a fourth part of the example of establishing a transmission of a multicast data stream in the mesh communication network;

FIG. 9E illustrates schematically a fifth part of the example of establishing a transmission of a multicast data stream in the mesh communication network;

FIG. 9F illustrates schematically a sixth part of the example of establishing a transmission of a multicast data stream in the mesh communication network;

FIG. 9G illustrates schematically a seventh part of the example of establishing a transmission of a multicast data stream in the mesh communication network;

FIG. 9H illustrates schematically an eighth part of the example of establishing a transmission of a multicast data stream in the mesh communication network;

FIG. 10 illustrates schematically a flow diagram of an alternative algorithm for processing a request to subscribe to a multicast data stream, received from a station device by a bridge device;

FIG. 11 illustrates schematically a flow diagram of an algorithm for processing a request to unsubscribe from a multicast data stream, received from a station device by a bridge device; and

FIG. 12 illustrates schematically an example of unsubscribing from a multicast data stream in the mesh communication network.

### DETAILED DISCLOSURE OF EMBODIMENTS

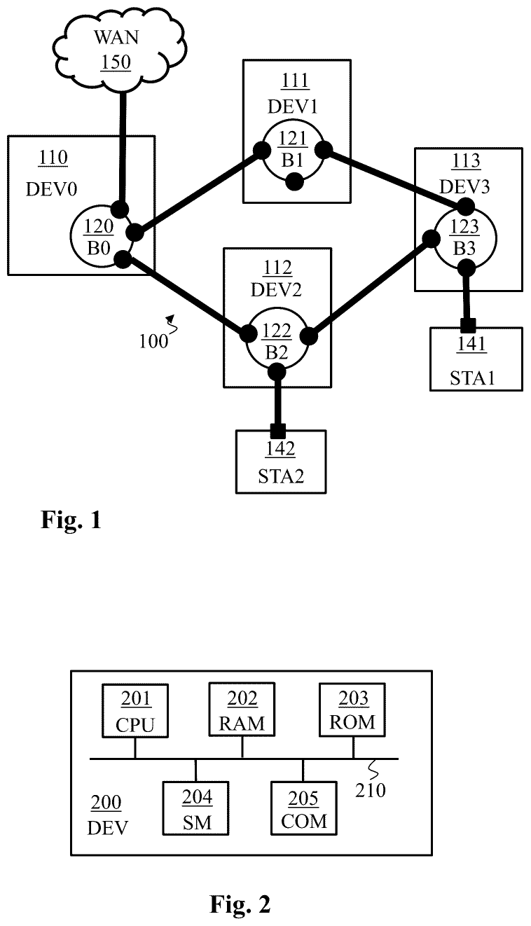

FIG. 1 thus illustrates schematically a mesh communication network 100 of the local area network LAN type that interconnects bridge devices B0 120, B1 121, B2 122, B3 123.

The bridge devices B0 120, B1 121, B2 122, B3 123 conjointly establish routing mechanisms for conveying data packets in the mesh communication network 100. The mesh communication network 100 is adapted and configured to accommodate station devices STA1 141, STA2 142 and to enable them to communicate through the mesh communication network 100. For example, the station devices STA1 141, STA2 142 can communicate with each other and/or communicate with a functionality of a device in which a said bridge device is included, such as a gateway functionality for accessing a wide area network WAN 150, e.g. for accessing the internet.

The station devices STA1 141, STA2 142 are for example computers, electronic tablets or multifunction mobile telephones, or any type of communicating electronic equipment (TV, audiovisual decoder, etc). An end device is spoken of equivalently.

The bridge devices are typically included in devices offering additional functionalities. Thus, in FIG. 1, the bridge device B0 120 is included in a device DEV0 110, the bridge device B1 121 is included in a device DEV1 111, the bridge device B2 122 is included in a device DEV2 112 and the bridge device B3 123 is included in a device DEV3 113. Thus, in one embodiment, a bridge device (the bridge device B0 120 in FIG. 1) is included in a residential gateway, and the other bridge devices (the bridge devices B1 121, B2 122 and B3 123 in FIG. 1) are respectively included in wireless local area network extenders, such as Wi-Fi extenders that make it possible to extend the Wi-Fi coverage of a local area network.

More precisely, to convey the data packets in the mesh communication network 100, each of the bridge devices B0 120, B1 121, B2 122 uses in parallel:
a first configuration of a first logical network, which is used for conveying data packets in unicast mode and is defined by a dynamic routing (also called adaptive routing) that optimises the costs between the bridge devices B0 120, B1 121, B2 122.
a second configuration of a second logical network, which is used for conveying data packets in broadcast mode and is defined according to a spanning tree by blocking one or more ports of the bridge devices B0 120, B1 121, B2 122 to eliminate one or more loops in the mesh communication network 100.

Conveying data packets in multicast mode relies on the first configuration, as described below.

For reasons of simplicity of description, FIG. 1 presents a mesh communication network comprising solely four bridge devices. It is however understood that what is described here applies to mesh communication networks having much more complex meshes with a larger quantity of bridge devices.

FIG. 2 illustrates schematically an example of a hardware arrangement adapted to implement a device DEV 200 in the mesh communication network 100, such as the devices DEV0 110, DEV1 111, DEV2 112 and DEV3 113.

The hardware arrangement presented comprises, connected by a communication bus 210: a processor or CPU (“Central Processing Unit”) 201; a random access memory RAM 202; a non-volatile memory ROM 203, or EEPROM (“Electrically Erasable Programmable ROM”), or of the flash type; a storage unit such as a storage medium SM 204, for example a hard disk drive HDD, or a storage medium reader, such as an SD (“Secure Digital”) card reader; and a communication interface manager COM 205.

The communication interface manager COM 205 enables the hardware arrangement presented to interact with other devices in the mesh communication network 100 or which are connected to the mesh communication network 100. The communication interfaces offer example Wi-Fi interfaces on various frequency bands (2.4 GHz, 5 GHz, 6 GHz), Ethernet interfaces, etc. It should be noted that several bridge device ports can be virtualised on one and the same physical communication interface.

The processor or CPU 201 is capable of executing instructions loaded in the random access memory 202, in particular from the non-volatile memory 203, or from the storage medium SM (such as an SD card) 204. When the hardware arrangement presented is powered up, the processor or CPU 201 is thus capable of reading instructions from the RAM 202 and executing them. These instructions form a computer program causing in particular the implementation, by the processor or CPU 201, of the steps, methods and behaviours described here in relation to the device to which the device DEV 200 corresponds.

All or some of the steps, methods and behaviours described here can thus be implemented in software form by executing a set of instructions by a programmable machine, for example a processor of the DSP (“digital signal processor”) type or a microcontroller, or be implemented in hardware form by a dedicated electronic machine or component (“chip”) or a set of dedicated components (“chipset”), for example an FPGA (“field-programmable gate array”) or an ASIC (“application-specific integrated circuit”) component. In general terms, the devices of the mesh communication network 100, such as the devices DEV0 110, DEV1 111, DEV2 112 and DEV3 113 (and consequently the bridge devices B0 120, B1 121, B2 122 and B3 123), comprise electronic circuitry adapted and configured to implement the steps, methods and behaviours described here.

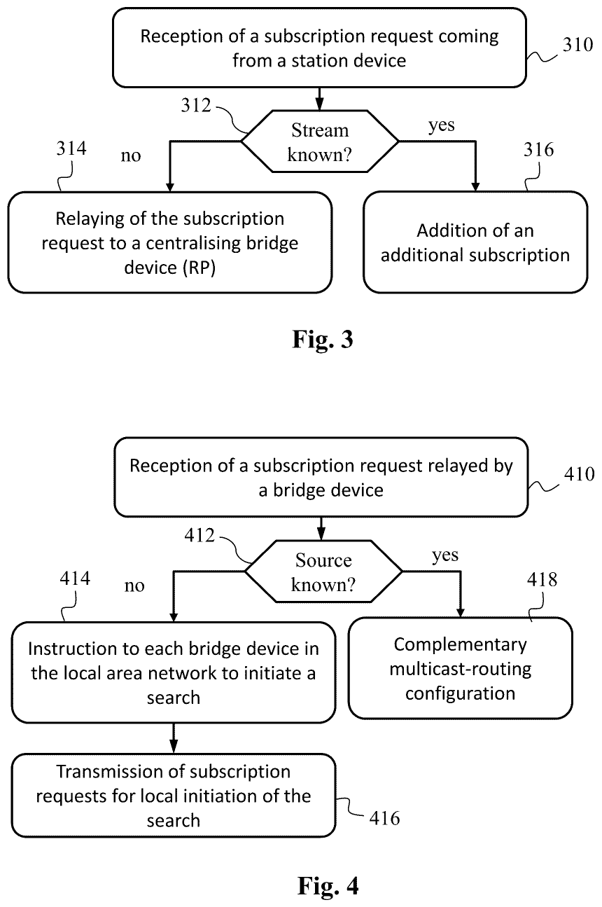

FIG. 3 illustrates schematically a flow diagram of an algorithm for processing a request to subscribe to a multicast data stream, received from a station device by a bridge device;

In a step 310, the bridge device in question receives the request to subscribe to the multicast data stream. The multicast data stream is typically identified by a layer 3 address (network layer) of the OSI (“Open Systems Interconnection”) model, e.g. an IP (“Internet Protocol”) address. The request to subscribe to the multicast data stream is for example a message of the JOIN type of the IGMP (“Internet Group Management Protocol”).

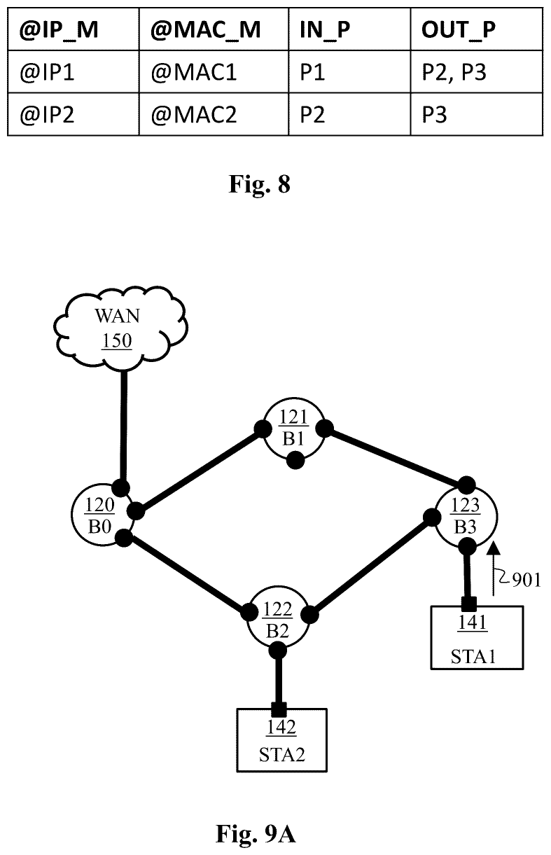

In a step 312, the bridge device in question checks whether the multicast data stream is known to said bridge device, i.e. whether the multicast data stream is already passing through said bridge device. A table of orientation of the multicast data streams, described below in relation to FIG. 8, can be used to do this. If such is the case, a step 316 is performed; otherwise a step 314 is performed.

In the step 314, the bridge device in question relays the request to subscribe to the multicast data stream to a centralising bridge device. For example, in the context of the PIM (“Protocol-Independent Multicast”) protocol in “sparse mode” version, the centralising bridge device is called “Rendezvous Point” (RP). The centralising bridge device is designated by prior configuration of the bridge devices B0 120, B1 121, B2 122 and B3 123 (for example at the time of installation or by election). The request to subscribe to the multicast data stream is relayed with a dedicated message, transmitted in unicast mode. For example, a PIM JOIN message of the PIM protocol can be used for warning the centralising bridge device (“Rendezvous Point”) that a station device wishes to subscribe to a multicast data stream. The relay message supplies at least one identification of the multicast data stream in question (typically its layer 3 address (network layer) of the OSI model, such as its IP address) and an identification of the station device in question (typically its layer 3 address (network layer) of the OSI model, such as its IP address).

In the step 316, the bridge device in question adds an additional subscription to the multicast data stream in question. This can cause the implementation of a complementary multicast-switching configuration in the bridge device in question. This is because it is possible that the multicast data stream in question is not yet propagated to the port of the bridge device via which the subscription request coming from the station device in question was received at the step 310. The bridge device in question then configures itself to propagate the multicast data stream in question also to this port. The multicast data stream in question is then transmitted to the station device in question. The bridge device in question can inform the centralising bridge device of this. The bridge device in question can inform the other bridge devices of the local area network of this.

In the event of a complementary multicast-switching configuration in the bridge device, as at the step 316, the multicast-switching configuration is updated with the addition of an output port for the multicast data stream. This output port is maintained in the complementary multicast-switching configuration, for the multicast data stream in question, until no further station device accessible via the port in question is subscribed to the multicast data stream in question.

To do this, the bridge device in question keeps a trace of each request to subscribe to the multicast data stream that said bridge device has received from a station device, as well as of the port of said bridge device via which said request to subscribe to the multicast data stream was received. With regard to the algorithm in FIG. 3 (or the one in FIG. 10 below), each request to subscribe to the multicast data stream that was thus received (from a said station device, such as at the step 310) comes from a station device that is connected to the bridge device in question (i.e. that accesses the mesh communication network 100 by means of said bridge device in question). This trace is kept in memory by the bridge device in question until the bridge device makes an unsubscribe request with regard to the multicast data stream in question (for example via a message of the LEAVE type of the IGMP protocol).

FIG. 3 presents a centralised arrangement. A distributed arrangement, in a variant, is presented below in relation to FIG. 10.

FIG. 4 illustrates schematically a flow diagram of an algorithm for processing, by the centralising bridge device, a request to subscribe to a multicast data stream, relayed by a bridge device. The algorithm in FIG. 4 is applied also when the centralising bridge device directly receives a request to subscribe to a multicast data stream from a station device that is connected to one of its ports.

In a step 410, the centralising bridge device receives the request to subscribe to a multicast data stream, which was relayed by a bridge device as described above in relation to FIG. 3. For example, the request to subscribe to a multicast data stream is written in a message PIM JOIN.

In a step 412, the centralising bridge device in question checks whether the multicast data stream is known to said centralising bridge device, i.e. whether the centralising bridge device has already been addressed for the multicast data stream in question. If such is the case, a step 418 is performed; otherwise a step 414 is performed.

In the step 414, the centralising bridge device sends an instruction to each bridge device B0 120, B1 121, B2 122 and B3 123 of the local area network (i.e., therefore, including itself) to initiate a search for the source of the multicast data stream in question. Example, the PIM protocol can be enhanced for this purpose with a message PIM JOINREQUEST intended to instruct a said bridge device to which the message PIM JOINREQUEST was addressed to initiate a search by sending a subscription request on each of its ports. This instruction is preferentially sent in unicast mode by the centralising bridge device to each other bridge device B0 120, B1 121, B2 122 and B3 123. The instruction indicates that the request is made on behalf of the station device in question (typically its layer 3 address (network layer) of the OSI model, such as its IP address) and therefore identifies the station device in question, as well as the multicast data stream in question (typically its layer 3 address (network layer) of the OSI model, such as its IP address).

In a particular embodiment, as illustrated in FIG. 1, where the local area network is connected to a wide area network WAN by means of a gateway incorporating a router (here the router B0 120), the source of the multicast data stream can be found within the local area network or then be accessible via the wide area network WAN. The search must then be initiated both on the local area network and on the wide area network WAN.

Next, in a step 416, the centralising bridge device itself applies the instruction to initiate the search for the source of the multicast data stream in question (local initiation of the search). To do this, the centralising bridge device transmits, on each of its ports, a request to subscribe to the multicast data stream in question. The request takes for example the form of a message of the JOIN type of the IGMP protocol. The subscription request is transmitted on behalf of the centralising bridge although it is made on behalf of the station device in question. The centralising bridge device recognises that the subscription request is actually transmitted on behalf of the station device in question rather than on its own behalf.

In a step 418, the centralising bridge device instructs a complementary multicast-routing configuration in the bridge device in question. This is because, at this stage, the multicast data stream in question is not yet propagated to the port of the bridge device via which the subscription request coming from the station device in question was received at the step 310 (otherwise the subscription would have been taken into account as soon as FIG. 3 was executed).

For example, the centralising bridge device, through its knowledge of the topology of the mesh communication network 100 and the costs of links by virtue of the adaptive routing, is capable of knowing via which bridge device or devices the multicast data stream in question is already passing in the mesh communication network. For example, the centralising bridge device sends a message to the bridge device as from which the multicast data stream must have available a new branch for reaching the station device in question. This bridge device, as from which the multicast data stream must have available a new branch, detects that the multicast data stream in question is already passing through it, and implements an update of its local multicast transmission configuration so as to make it possible to propagate the multicast data stream in question also as far as the station device in question. As the description describes below in relation to FIG. 7, the bridge device in question fills in its table of orientation of the multicast data streams (addition of an output port) and then re-transcribes it in its switching table of the multicast data streams. And so on, the centralising bridge device sends such a message to all the bridge devices on the branch, according to the first configuration of a first logical network, which are to be configured in order to reach the station device in question.

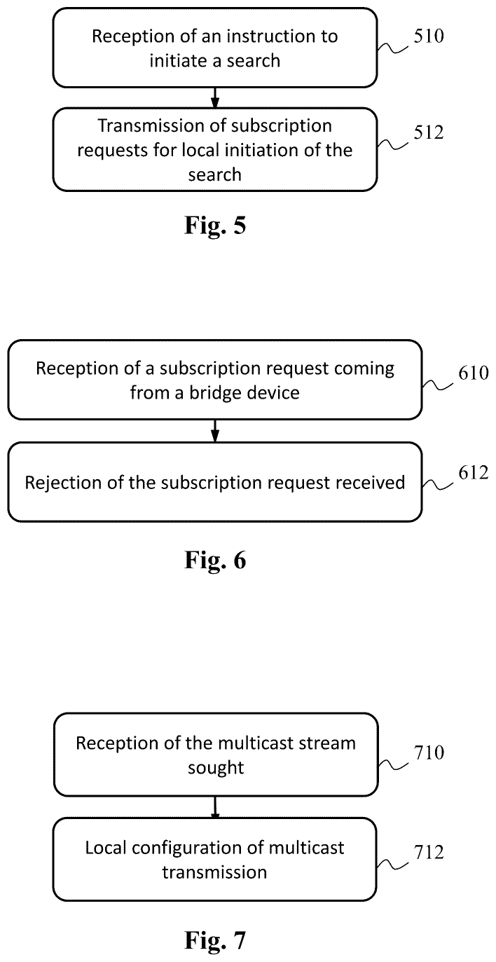

FIG. 5 illustrates schematically a flow diagram of an algorithm for processing, by a bridge device, an instruction to initiate a search for the source of a multicast data stream on behalf of a station device.

In a step 510, the bridge device in question receives the instruction to initiate the search for the source of a multicast data stream. The instruction indicates that the request is made on behalf of the station device in question (typically its layer 3 address (network layer) of the OSI model, such as its IP address) and therefore identifies the station device in question, as well as the multicast data stream in question (typically its layer 3 address (network layer) of the OSI model, such as its IP address).

In a step 512, the bridge device in question transmits, on each of its ports, a request to subscribe to the multicast data stream in question. The request takes for example the form of a message of the JOIN type of the IGMP protocol. The subscription request is transmitted on behalf of the bridge device in question although it is made on behalf of the station device in question. The bridge device in question recognises that the subscription request is actually transmitted on behalf of the station device in question rather than on its own behalf. This makes it possible to ensure that it is able to seek, when the multicast data streams sought will enter the mesh formed by the interconnection of the bridge devices, the best route (according to the first configuration of a first logical network) as far as the station device in question.

FIG. 6 illustrates schematically a flow diagram of an algorithm for processing, by a bridge device, a request to subscribe to a multicast data stream, received from another bridge device.

The request to subscribe to a multicast data stream results from a search for the source of the multicast data stream, as initiated by said other bridge device at the step 416 or 512.

In a step 610, the bridge device in question receives the request to subscribe to a multicast data stream coming from said other bridge device. Since it itself received the instruction to initiate the search for the source of the multicast data stream in question, this request to subscribe to the multicast data stream has not been taken into account or been relayed by the bridge device in question.

Thus, in a step 612, the bridge device in question discards (or rejects) the request to subscribe to the multicast data stream that was received from said other bridge device.

For example, the bridge device in question can recognise the origin (station device or bridge device) of the request to subscribe to the multicast data stream by means of source-address information (of layer 3 (network layer) and/or of layer 2 (link layer) of the OSI model, e.g. respectively IP address and/or MAC address).

FIG. 7 illustrates schematically a flow diagram of an algorithm for reacting, by a bridge device, to a reception of a multicast data stream for which a subscription request was previously made on behalf of a station device.

In a step 710, the bridge device in question receives the multicast data stream in question. The bridge device in question finds a trace indicating that this multicast data stream was the object of a subscription request by virtue of an instruction to initiate a search for its source (step 416 or 512).

In a step 712, the bridge device in question implements a local multicast-transmission configuration so as to make it possible to propagate the multicast data stream in question in the local area network as far as the station device concerned. To do this, the bridge device in question notes via which port (first port) the multicast data stream is received, and determines via which port (second port) the station device in question is accessible according to the first configuration (the one for the unicast transmissions), so as to optimise the route as far as the station device concerned. The bridge device configures itself so as to allow switching, from the first port the second port, of the multicast data stream in question.

In a particular embodiment, the bridge device fills in a table of orientation of the multicast data streams, as described below in relation to FIG. 8, and then re-transcribes it in a switching table of the multicast data streams (at layer 2 (link layer) of the OSI model). This avoids using the second configuration of the second logical network (the one for the data broadcasts) in the context of multicast transmissions and therefore optimises the use of the network.

In a variant to the algorithm in FIG. 7, the bridge device in question implements the local multicast-transmission configuration (so as to make it possible to propagate the multicast data stream in question in the local area network as far as the station device concerned) on reception of a message confirming the taking account of a said request to subscribe to the multicast data stream that was transmitted by said bridge device during the search for the source of said multicast data stream.

In another variant, the message confirming the taking account of a said request to subscribe to the multicast data stream that was transmitted by said bridge device during the search for the source of said multicast data stream is relayed to the centralising bridge device. And it is on instruction of the centralising bridge device that the local multicast-transmission configuration (so as to make it possible to propagate the multicast data stream in question in the local area network as far as the station device concerned) is applied.

FIG. 8 illustrates schematically a table of orientation of the multicast data streams.

Each bridge device B0 120, B1 121, B2 122 and B3 123 of the local area network implements it own table of orientation of the multicast data streams.

This table of orientation of the multicast data streams is constructed and updated by the bridge device B0 120, B1 121, B2 122 and B3 123 concerned to facilitate the establishment of switchings of multicast data streams in the local network according to the subscriptions requested.

The table of orientation of the multicast data streams contains a match between:
a layer 3 address (network layer) of the OSI model of the multicast data stream, denoted @IP_M, typically its IP address;
a layer 2 address (link layer) of the OSI model of the multicast data stream, denoted @MAC_M, typically its MAC address;
an identification, denoted IN_P, of the input port of the bridge device in question, via which the multicast data stream enters; and
an identification, denoted OUT_P, of the output port or ports of the bridge device in question, via which the multicast data stream leaves.

For illustration purposes, FIG. 8 thus shows, for a given bridge device, a content of a table of orientation of the multicast data streams including:.
a first multicast data stream, having a layer 3 address (network layer) of the OSI model denoted @IP1 and a layer 2 address (link layer) of the OSI model denoted @MAC1, and for which the input port is a port denoted P1 and two output ports denoted P2 and P3 are declared;
a second multicast data stream, having a layer 3 address (network layer) of the OSI model denoted @IP2 and a layer 2 address (link layer) of the OSI model denoted @MAC2, and for which the input port is the port P2 and the single output port is the port P3.

In the situation described by the table of orientation of the multicast data streams in FIG. 8, the first multicast data stream therefore enters via the port P1 of the bridge device in question and is switched to the ports P2 and P3, whereas the second multicast data stream enters via the port P2 of the bridge device in question and is switched solely to the port P3.

It should be noted that the match between a layer 3 address (network layer) of the OSI model of a multicast data stream and a layer 2 address (link layer) of the OSI model of the multicast data stream can be obtained conventionally by applying a conversion rule. For example, in the case of an IPv6 address of a multicast data stream, the corresponding MAC address is obtained by prefixing the last 4 bytes of said IPv6 address by the value 0x3333, as defined in the normative document RFC 4291; and, in the case of an IPv4 address of a multicast data stream, the corresponding MAC address can be obtained by prefixing the last 23 bits of said IPv4 address by the value 0x01005E followed by a bit at 0.

In a particular embodiment, each time the table of orientation of the multicast data streams is updated by a bridge device, the bridge device in question informs the centralising bridge device thereof. Thus the centralising bridge device is conversant with the conveying of multicast data streams in the mesh communication network 100. One possible variant is that each bridge device is informed of the updates of the tables of orientation of the multicast data streams, and thus each centralising bridge device is conversant with the conveying of multicast data streams in the mesh communication network 100.

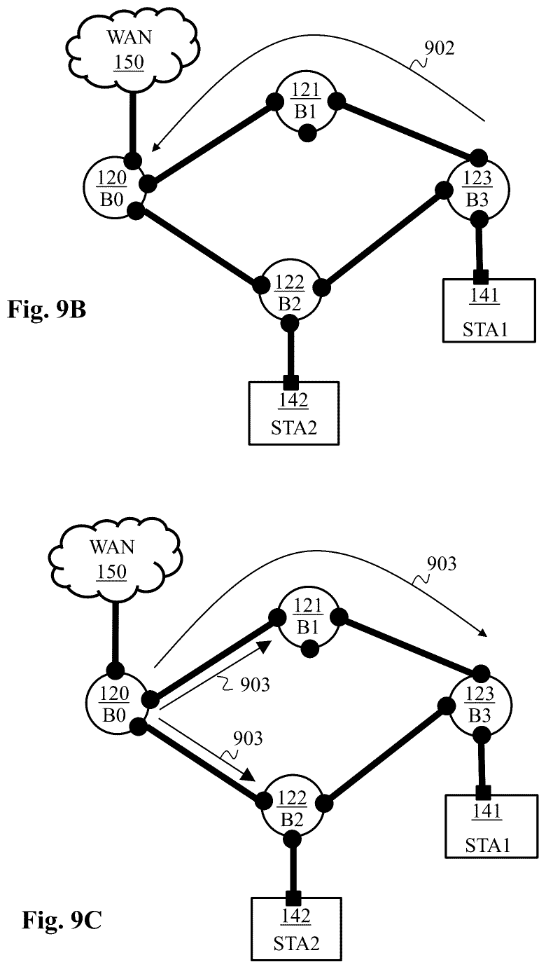

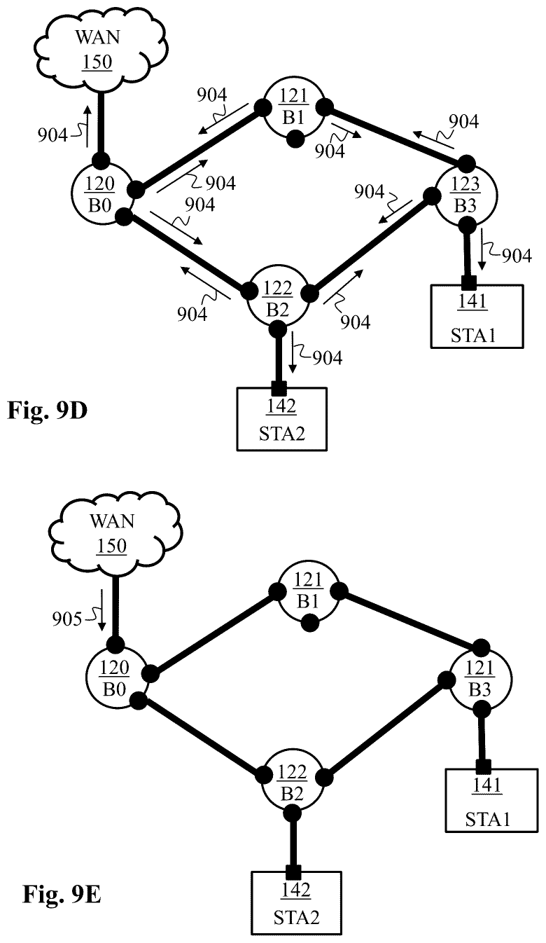

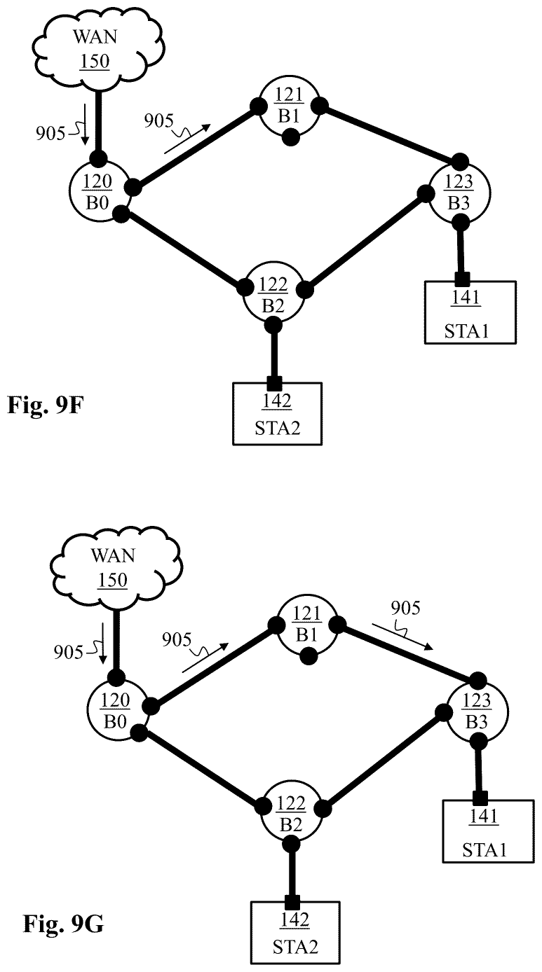

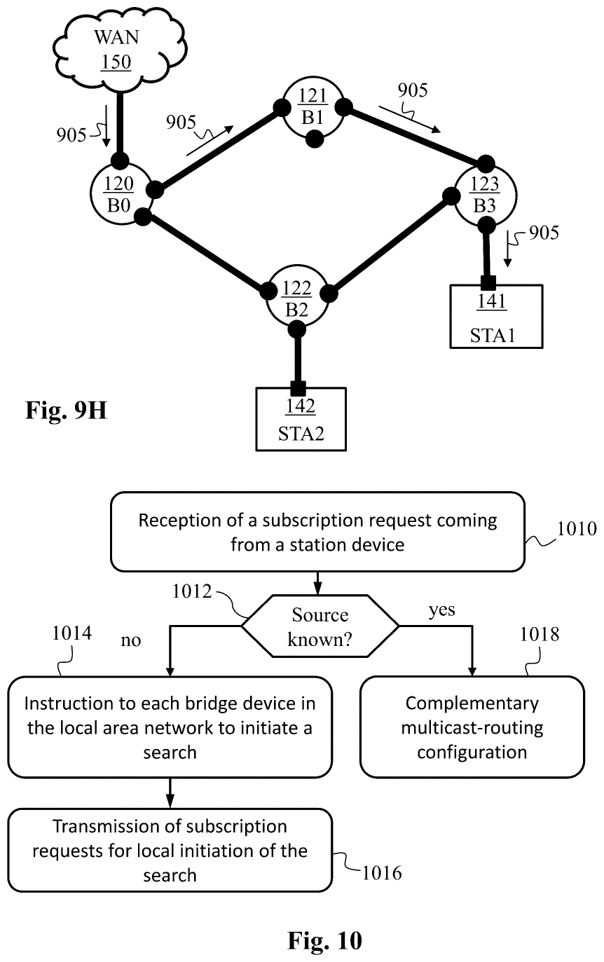

FIGS. 9A to 9H illustrate an example of application of the algorithms described above in relation to FIGS. 3 to 7. FIGS. 9A to 9H thus illustrate schematically an example of establishing a transmission of the multicast data stream in the mesh communication network 100.

It is considered in the context of the example illustrated in FIGS. 9A to 9H that the centralising bridge device is the bridge device B0 120.

In FIG. 9A, the station device STA1 141 transmits a request 901 to subscribe to a multicast data stream. For example, the request 901 is an IGMP JOIN message. This request 901 is received by the bridge device B3 123, for example via its port 2. We consider by way of illustration that the source of the multicast data stream question is accessible via the wide area network WAN 150 and that no station device has yet subscribed to this multicast data stream.

In FIG. 9B, by execution of the algorithm in FIG. 3, the bridge device B3 123 transmits, to the bridge device B0 120 as centralising bridge device, a message 902 relaying the request to subscribe to the multicast data stream. For example, the message 902 is a PIM JOIN message.

In FIG. 9C, by execution of the algorithm in FIG. 4, the bridge device B0 120 as centralising bridge device transmits to each other bridge device B1 121, B2 122 and B3 123 an instruction message 903 to instruct that a search for the source of the multicast data stream in question should be initiated. For example, the instruction message is a PIM JOINREQUEST message as aforementioned.

In FIG. 9D, by execution of the algorithm in FIG. 5 (step 416 for the bridge device B0 120), each bridge device transmits, in its name, but in behalf of the station device concerned, a request 904 to subscribe to a multicast data stream on each of its ports. For example, the request 904 is an IGMP JOIN message. Such a request 904 is in particular transmitted on the wide area network WAN 150.

In FIG. 9E, the multicast data stream 905 is received from the wide area network WAN 150 by the bridge device B0 120, for example via its port 0.

Considering that the route to the station device STA1 141 exits the bridge device B0 120 via its port 1 destined for the bridge device B1 121, the bridge device B0 120 establishes a switching rule (layer 2 (link layer) of the OSI model) so that the multicast data stream 905 arriving via its port 0 is propagated by its port 1, as illustrated in FIG. 9F. The multicast data stream 905 is then received from the bridge device B0 120 by the bridge device B1 121, for example via its port 0.

Considering that the route to the station device STA1 141 exits the bridge device B1 121 via its port 2 destined for the bridge device B3 123, the bridge device B1 121 establishes a switching rule (layer 2 (link layer) of the OSI model) so that the multicast data stream 905 arriving via its port 0 is propagated by its port 2, as illustrated in FIG. 9G. The multicast data stream 905 is then received from the bridge device B1 121 by the bridge device B3 123, for example via its port 0.

The bridge device B3 123 establishes a switching rule (layer 2 (link layer) of the OSI model) so that the multicast data stream 905 arriving via its port 0 is propagated by its port 2, as illustrated in FIG. 9H. The station device STA1 141 then receives the multicast data stream 905, and the conveying of the multicast data stream 905 is optimised in the mesh communication network 100.

FIG. 10 illustrates schematically a flow diagram of an alternative algorithm for processing a request to subscribe to a multicast data stream, received from a station device by a bridge device.

In a step 1010, the bridge device in question receives the request to subscribe to the multicast data stream, as at the step 310.

In a step 1012, the bridge device in question checks whether the multicast data stream is known to said bridge device, i.e. whether the multicast data stream is already passing through said bridge device. The table of orientation of the multicast data streams, described below in relation to FIG. 8, can be used to do this. If such is the case, a step 1018 is performed; otherwise a step 1014 is performed.

In the step 1014, the bridge device sends an instruction to each bridge device B0 120, B1 121, B2 122 and B3 123 of the local area network (i.e., therefore, including itself) to initiate a search for the source of the multicast data stream in question. For example, the aforementioned PIM JOINREQUEST message is used This instruction is preferentially sent in unicast mode. The instruction indicates that the request is made on behalf of the station device in question (typically its layer 3 address (network layer) of the OSI model, such as its IP address) and therefore identifies the station device in question, as well as the multicast data stream in question (typically its layer 3 address (network layer) of the OSI model, such as its IP address). This causes the triggering of the algorithm in FIG. 5 by the bridge devices B0 120, B1 121, B2 122 and B3 123.

In a step 1016, the bridge device in question itself applies the instruction to initiate the search for the source of the multicast data stream in question (local initiation of the search). To do this, the bridge device in question transmits, on each of its ports, a request to subscribe to the multicast data stream in question. The request takes for example the form of a message of the JOIN type of the IGMP protocol, as already described. The subscription request is transmitted on behalf of the bridge device in question although it is made on behalf of the station device in question. The bridge device in question recognises that the subscription request is actually transmitted on behalf of the station device in question rather than on its own behalf.

In the step 1018, the bridge device in question adds an additional subscription to the multicast data stream in question. This can cause the implementation of a complementary multicast-switching configuration in the bridge device in question. This is because it is possible that the multicast data stream in question is not yet propagated to the port of the bridge device via which the subscription request coming from the station device in question was received at the step 1010. The bridge device in question then configures itself to propagate the multicast data streaming question also to this port. The multicast data stream in question is then transmitted to the station device in question.

In the event of a complementary multicast switching configuration in the bridge device, as at the step 316, the multicast switching configuration is updated with the addition of an output port for the multicast data stream. This output port is maintained in the complementary multicast switching configuration, for the multicast data stream in question, until no further station device accessible via the port in question is subscribed to the multicast data stream in question.

For example, the bridge device in question, through its knowledge of the topology of the mesh communication network 100 and the costs of links by virtue of the adaptive routine, is capable of knowing via which bridge device or devices the multicast data stream in question is already passing in the mesh communication network. For example, the bridge device in question sends a message to the bridge device as from which the multicast data stream must have available a new branch for reaching the station device in question. This bridge device, as from which the multicast data stream must have available a new branch, detects that the multicast data stream in question is already passing through it, and implements an update of its local multicast transmission configuration so as to make it possible to propagate the multicast data stream in question also as far as the station device in question. As the description describes below in relation to FIG. 7, the bridge device in question fills in its table of orientation of the multicast data streams (addition of an output port) and then re-transcribes it in its switching table of the multicast data streams. And so on, the bridge device in question sends such a message to all the other bridge devices on the branch, according to the first configuration of the first logical network, which are to be configured in order to reach the station device in question.

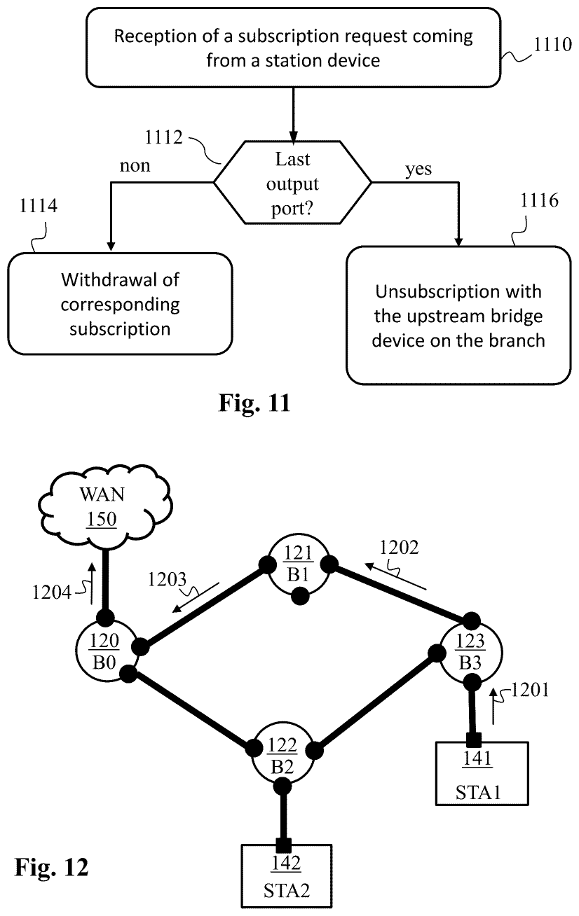

FIG. 11 illustrates schematically a flow diagram of an algorithm for processing a request to unsubscribe from a multicast data stream, received from a station device by a bridge device.

In a step 1110, the bridge device in question receives the request to unsubscribe from the multicast data stream, coming from a station device. The request to unsubscribe marks the end of the subscription that had been requested by the station device at the step 310 or 1010.

In a step 1114, the bridge device in question takes account of the unsubscribing of the station device in question with regard to the multicast data stream concerned.

The bridge device examines whether a multicast-switching reconfiguration in the bridge device in question is necessary. This is because it is possible that the multicast data stream in question no longer has to be propagated to the port of the bridge device via which the unsubscribing request coming from the station device in question was received at the step 1110. For example, considering the example in FIG. 8, the unsubscribing of the station device makes it unnecessary for the multicast data stream identified by the address @IP1 to be propagated to the port P3. In which case, a multicast-switching reconfiguration (optionally by means of a corresponding update of the table of orientation of multicast data streams) is implemented to withdraw the propagation to the port P3.

The bridge device also examines, in a step 1112, whether a multicast-switching reconfiguration in the bridge device means that the multicast data stream in question no longer has to be propagated to any port in the bridge device in question. For example, considering the example in FIG. 8, the unsubscribing of the station device makes it unnecessary for the multicast data stream identified by the address @IP2 to be propagated to the port P3. In which case, a multicast-switching reconfiguration (optionally by means of a deletion of the corresponding line in the table of orientation of multicast data streams) is implemented to withdraw the propagation of the multicast data stream in the bridge device in question; but in addition the unsubscribing must travel along the branch concerned in the mesh communication network. Thus, in a step 1116, the bridge device transmits, to the bridge device upstream on the branch, i.e. the bridge device that is connected to it via the input port of the multicast data stream concerned, an unsubscribe request for the multicast data stream in question.

In a particular embodiment, the bridge device in question informs the concentrating bridge device of any multicast-switching reconfiguration thus implemented, so that the centralising bridge device can know at any moment which multicast data stream is being propagated in the mesh communication network 100 and by which routes/branches.

FIG. 12 illustrates schematically an example of unsubscribing from a multicast data stream in the mesh communication network.

The station device STA1 141 transmits a request 1201 to unsubscribe from a multicast data stream. For example, the request 1201 is an IGMP LEAVE message that corresponds to the same multicast data stream as the IGMP JOIN message of FIG. 9A. This request 1201 is received by the bridge device B3 123, for example via its port 2.

The bridge device B3 123 realises that no further station device is then subscribing to the multicast data stream through it, and stops the propagation of the multicast data stream. The bridge device B3 123 informs the bridge device B1 121 of this by an unsubscribe request 1202 with regard to the multicast data stream. For example, the request 1202 is an IGMP LEAVE message.

Following reception of the request 1202, the bridge device B1 121 realises that it is no longer necessary to propagate the multicast data stream by means of itself, and stops the propagation of the multicast data stream. The bridge device B1 121 informs the bridge device B0 120 of this by an unsubscribe request 1203 with regard to the multicast data stream. For example, the request 1202 is an IGMP LEAVE message.

Following reception of the request 1203, the bridge device B0 120 realises that it is no longer necessary to propagate the multicast data stream by means of itself, and stops the propagation of the multicast data stream. The bridge device B0 120 transmits an unsubscribe request 1204 with regard to the multicast data stream in the direction of the source of the multicast data stream. For example, the request 1203 is an IGMP LEAVE message that is consistent with the IGMP JOIN message 904 transmitted in the direction of the wide area network WAN 150 in FIG. 9D.

If on reception of the request 1203, the bridge device B0 120 had realised that the multicast data stream was also been propagated via its port 2 (for example to enable the station device STA2 142 to receive the multicast data stream in question), then the bridge device B0 120 would have stopped the propagation of the multicast data stream in question to its port 1 but would have maintained the propagation of the multicast data stream in question to its port 2.

1. A method for transmitting data packets in a mesh communication network of the local area network type that interconnects bridge devices, each bridge device using in parallel: a first configuration of a first logical network, which is used for conveying data packets in unicast mode and is defined by a dynamic routing between the bridge devices; and a second configuration of a second logical network that is used for conveying data packets in broadcast mode and is defined according to a spanning tree by blocking one or more ports of the bridge devices to eliminate one or more loops in the mesh communication network, the method comprising:
following a first subscription request received from a station device connected to the local area network, instructing each bridge device to initiate a search for the source of the multicast data stream so that each bridge device transmits, on each of its ports, a second request to subscribe to the multicast data stream and does not take account of any such second request to subscribe to the multicast data stream coming from any other said bridge device; and
when the multicast data stream is received via an input port of a said bridge device, configuring said bridge device to switch the multicast data stream from the input port to an output port in the direction of the station device according to the first configuration of a first logical network.

2. The method according to claim 1, wherein the first subscription request is received from the station device by a said bridge device that relays the first subscription request to a centralising bridge device, which then sends to each bridge device an instruction to initiate the search for the source of the multicast data stream.

3. The method according to claim 1, wherein the subscription request received from the station device is received by a said bridge device, which then sends to each bridge device an instruction to initiate the search for the source of the multicast data stream.

4. The method according to claim 1, wherein each second subscription request is transmitted on behalf of the bridge device in question although it is made on behalf of the station device in question.

5. The method according to claim 1, wherein each bridge device implements a table of orientation of multicast data streams containing, for each multicast data stream passing through said bridge device:
a layer 3 address of the OSI model of said multicast data stream;
a layer 2 address of the OSI model of the multicast data stream, which was obtained by applying a conversion rule using said layer 3 address of the OSI model of said multicast data stream;
an identification of the input port of said bridge device for said multicast data stream; and
an identification of each output port of said bridge device for said multicast data stream;
and wherein each bridge device retranscribes its table of orientation of multicast data streams in a switching table for the multicast data streams at layer 2 of the OSI model.

6. (canceled)

7. A non-transitory information storage medium comprising instructions causing an implementation of the method according to claim 1, when the instructions are read from the information storage medium and executed by a processor.

8. A bridge device intended to be used in a mesh communication network of the local area network type, the bridge device using in parallel: a first configuration of a first logical network, which is used for conveying data packets in unicast mode and is defined by a dynamic routing between bridge devices in the mesh communication network; and a second configuration of a second logical network that is used for conveying data packets in broadcast mode and is defined according to a spanning tree by blocking one or more ports of the bridge devices in the mesh communication network to eliminate one or more loops, the bridge device comprising electronic circuitry configured to:
following a first subscription request received from a station device connected to the local area network, instruct each bridge device in the mesh communication network to initiate a search for the source of the multicast data stream so that each bridge device in the mesh communication network transmits, on each of its ports, a second request to subscribe to the multicast data stream and does not take account of any such second request to subscribe to the multicast data stream coming from any other said bridge device in the mesh communication network; and
when the multicast data stream is received via an input port of a said bridge device, configure said bridge device to switch the multicast data stream from the input port to an output port in the direction of the station device according to the first configuration of a first logical network.
